(19) United States
(12) Patent Application Publication
(10) Pub. No.: US 2002/0090923 A1
(43) Pub. Date: Jul. 11, 2002

(54) Synchronization timing correcting circuit and method

(76) Inventor: Kimio Muramoto, Kanagawa (JP)

Correspondence Address: STEVEN I. WEISBURD, ESQ., DICKSTEIN, SHAPIRO, MORIN & OSHINSKY LLP, 1177 AVENUE OF THE AMERICAS, 41ST FLOOR, NEW YORK, NY, 10036-2714, US

(21) Appl. No.: 10/035,192

(22) Filed: Jan. 4, 2002

(30) Foreign Application Priority Data
Jan. 5, 2001 (JP) 2001-000803

(51) Int. Cl. H04B 1/18

(52) U.S. Cl. 455/192.2; 455/192.1; 455/561

(57) ABSTRACT

Deviation amount judging means 108 compares correlation values from respective correlating devices 105₁ to 105₈ with one another to detect a deviation amount and a deviation direction of a frequency central value currently set from a synchronization timing at which the maximum correlation value can be obtained and outputs a window position changing signal to window moving means 107. The window moving means 107 performs change of the frequency central value of a window width on the basis of the window position changing signal from the deviation amount judging means 108. When the correlation value maximum timing moves from the central frequency due to an AFC error, the position of the window itself is moved corresponding to the movement of the correlation value maximum timing so that the correlation value maximum timing is prevented from deviating from the window even when the window width is made narrow.

### FIELD OF THE INVENTION

The present invention relates to a mobile communication system which uses a Wide-band Code division Multiple Access (hereinafter, referred to as a W-CDMA) technique, and in particular to a synchronization timing correcting circuit for correcting a synchronization timing of a base station which has been captured once and a method therefor.

### BACKGROUND OF THE INVENTION

In recent years, as a communication system used in a mobile communication system, attention is paid to a CDMA communication system which is less subject to interference or obstruction. This CDMA system is a system where a user signal to be transmitted is transmitted in a spread manner as a spreading signal on a transmission side and inverse-spreading is performed by using the same spreading code as the spreading signal to obtain the original user signal on a reception side. For this reason, in the CDMA system, unless synchronization in phase between the spreading code sequences of the transmission side and the reception side is achieved, the inverse-spreading can not be preformed on the reception side.

From the above reason, in the CDMA system, a frequency control is performed by using a auto-frequency control (hereinafter, referred to as “AFC”) in order to conform the synchronization frequency of the mobile station with the synchronization frequency of the base station. However, the reference frequency etc. of the base station and the mobile station vary depending on time elapse, temperature change or the like. Therefore, the control for capturing the synchronization of the base station using the AFC is performed in a two-stage manner. That is, two stages of an initial synchronization timing capture (searching) for capturing the synchronization timing of the base station and a synchronization timing correcting (tracking) for correcting the synchronization timing which has been capturing once are performed separately.

FIG. 1 is a block diagram showing a CDMA receiving apparatus provided with a conventional synchronization timing correcting circuit. This CDMA apparatus comprises a radio receiving section 101, an A/D converter 102, an AFC section 103, an input signal processing timing control section 504, 64 correlating devices 105₁, to 105₆₄, and a synchronization timing detecting section 506.

The radio receiving section 101 demodulates a radio signal received via an antenna to convert it to a base band signal.

The A/D converter 102 converts the base band signal from the radio receiving section 101 to a digital signal by sampling the base band signal at a sampling rate of N times a chip rate.

Th AFC section 103 is input with the digital signal from the A/D converter 102 to perform capturing a synchronization timing. Then, the AFC section 103 outputs the information about the obtained synchronization timing to the input signal processing timing control section 504.

The input signal processing timing control section 504 controls a processing timing of signals from the A/D converter 102 and generates signals from the signals from the A/D converter 102 within the range of ±32 clocks about a central frequency of a synchronization timing captured by the AFC section 103 to output the generated signals into the correlation devices 105₁ to 105₆₄, respectively.

The sixty-four correlating devices 105₁ to 105₆₄ perform correlation value calculations between the signals whose timings are in the range of ±32 clocks about the central frequency and which are outputted from the input signal processing timing control section 504 and predetermined spreading codes, respectively. The number of samplings corresponding to this 64 clocks is called “window width”. That is, the window means a range where the synchronization timing captured once is monitored.

FIG. 2 is a diagram showing that the window width controlled by the input signal processing timing control section 504 is a window of 64 clocks. As shown in FIG. 2, correlation calculations between signals within the range of ±32 chips about the central frequency and the spreading codes are preformed. Then, an image of correlation values obtained from the correlating devices 105₁ to 105₆₄ is shown in FIG. 3.

The synchronization timing detecting section 506 outputs synchronization timing information for transmitting a timing (a correlation value maximum timing) from which the correlation value of the maximum value among the correlation values outputted from the correlating devices 105₁ to 105₆₄ is obtained to the next stage as a synchronization timing. In the next stage, such a processing as an inverse-spreading or despreading process is performed on the basis of this synchronization timing information.

In this conventional synchronization timing correcting circuit, the reason whey the window width is set to the 64 clocks is for obtaining the correlation values in all the timings which can be taken within the range of the maximum error where frequency deviation may occur. Specifically, the window width is set according to the following calculation.

For example, in a case that the longest operation time for which data is captured is 2048 frames (=20 seconds), it is assumed that the maximum error of 0.1 ppm occurs even when the AFC is locked. When one frame comprises 15 time slots, one time slot comprises 10 symbols, a spreading rate is 256, and over-sampling of four times is used, the maximum error shift to be estimated becomes 4×256×10×15×2048×(0.1×10⁻⁶)=31.5 clocks. Therefore, when the number of samplings is small, or the window width is narrow, there is a possible that a normal reception can not be achieved. Accordingly, in the conventional synchronization timing correcting circuit, the window width is set to 64 clocks in order to obtain all the correlation values in the range of ±64 clocks about the central frequency. Incidentally, since the range of the maximum error where a frequency shift occurs varies according to differences in the maximum error in the state that the AFC section has been locked, the number of time slots per frame, the number of over-samplings, the spreading rate or the like, the window width required is not fixed to 64 clocks but it varies.

As explained above, in the conventional synchronization timing correcting circuit, such a configuration is employed that the frequency shift due to the error of the AFC is predicted in advance, the correlation values about all the timings (the window of the central frequency ±64 clocks) which may be taken within the range of the maximum error where the frequency shift may occur is obtained so that at timing where the maximum correlation value can be obtained is selected from the timings as a synchronization timing.

For this reason, in a case that a circuit scale per one of the correlating devices 105₁ to 105₆₄ is 10K gates, the circuit scale of 10K gates×64=640k gates is required in the conventional synchronization timing correcting circuit. Also, since it is necessary to perform calculation processing in the respective correlating devices 105₁ to 105₆₄, the amount of calculation processing is increased according to increase in window width.

In the conventional synchronization timing correcting circuit, there is a problem that the circuit scale and the amount of calculation processing are increased because correlating devices of the number corresponding to the window width determined in view of the maximum frequency deviation is required.

### SUMMARY OF THE INVENTION

An object of the present invention is to provide a synchronization timing correcting circuit where a window width required can be set to be narrower, and the circuit scale and the amount of calculation processing can be reduced by decreasing the number of correlating devices.

In order to achieve the above object, according to an aspect of the present invention, there is provided a synchronization timing correcting circuit for correcting a synchronization timing of a base station which has been once captured, comprising: an input signal processing timing control section which has window moving means for, on the basis of a window position changing signal for instructing a change of a frequency central value of a window defining a range for monitoring a synchronization timing which has been once captured, changing the frequency central value of the window, and which produces signals within the window about the frequency central value set by the window moving means from a signal received from a base station;

a plurality of correlating devices which perform correlation values between the signals produced by the input signal processing timing control section and predetermined spreading codes, respectively; and

a synchronization timing detecting section which has deviation amount judging means for detecting a deviation amount and a deviation direction of a frequency central value of a window set currently from a synchronization timing which is a timing at which the correlation value becomes maximum by comparing the respective correlation values with one another to determine a movement amount of the central frequency of the window to be moved on the basis of the deviation amount and the deviation direction, and outputting the movement amount determined to the window moving means as the window position changing signal.

Also, the deviation amount judging means is configured so as to take an average value of a fixed period between the frequency central value set currently and the synchronization timing and change the frequency central value of the window when the average value exceeds a predetermined reference value.

Also, the deviation amount judging means may be configured so as to calculate a judgement value Y(n) using a calculation equation

Y(n)=Z×Y(n−1)+(1+Z)×T,

where Y(n) is a judgement value which is a criterion about whether or not a frequency central value of a window should be changed, Y(n−1) is the previous judgement value, T is the deviation amount detected, and Z is a calculation coefficient having a value larger than 0 and smaller than 1, and change the frequency central value of the window when the judgement value Y(n) exceeds a predetermined reference value.

Further, the deviation amount judging means may move the frequency central value of the window by one clock or may move it by the deviation amount detected.

According to the invention, when the correlation value maximum timing due to AFC error moves or shifts from the central frequency, the position of the window itself is moved or shifted to correspond to the movement of the correlation value maximum timing so that it is made possible to capture the correlation value maximum timing without the correlation value maximum timing deviating from the window. Accordingly, the window width required can be set to be narrower and the number of correlating devices required can be reduced, thereby reducing a circuit scale and the amount of calculation processing.

### BRIEF DESCRIPTION OF THE DRAWINGS

FIG. 1 is a block diagram showing a CDMA receiver provided with a conventional synchronization timing correcting circuit;

FIG. 2 is a diagram showing a window whose window width is 64 clocks, which is controlled by an input signal processing timing control section 504;

FIG. 3 is a diagram showing an image of correlation values obtained by correlating devices 105₁ to 105₆₄;

FIG. 4 is a block diagram showing a configuration of a CDMA receiver provided with a synchronization timing correcting circuit of a first embodiment of the present invention;

FIG. 5 is a flowchart showing an operation of the synchronization timing correcting circuit of the first embodiment of the present invention;

FIG. 6A and 6B are diagrams showing a timing correcting method when a correlating value maximum timing is moved towards (+side) within a window relative to a central frequency; and

FIG. 7A and 7B are diagrams showing a timing correcting method when a correlating value maximum timing is moved towards (−side) within a window relative to a central frequency.

### DESCRIPTION OF THE PREFERRED EMBODIMENTS

Next, embodiments of the present invention will be explained with reference to the drawings.

(First Embodiment)

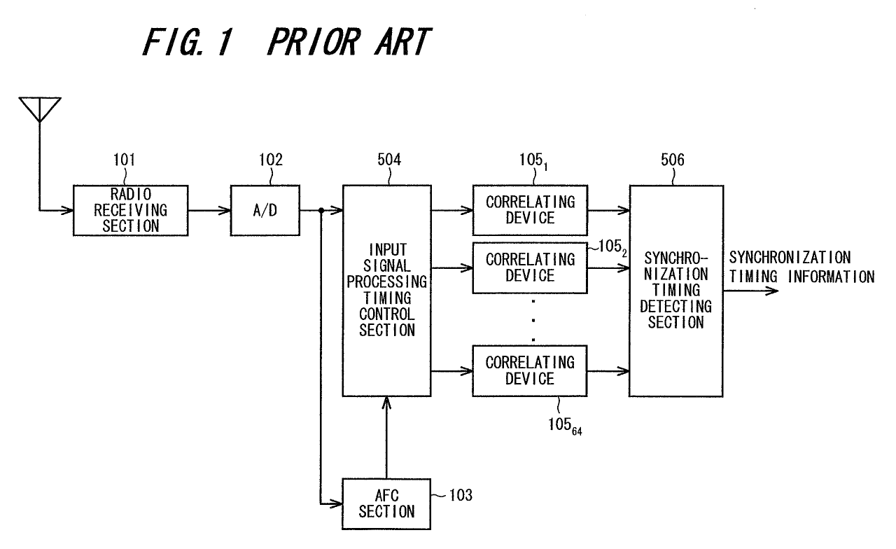

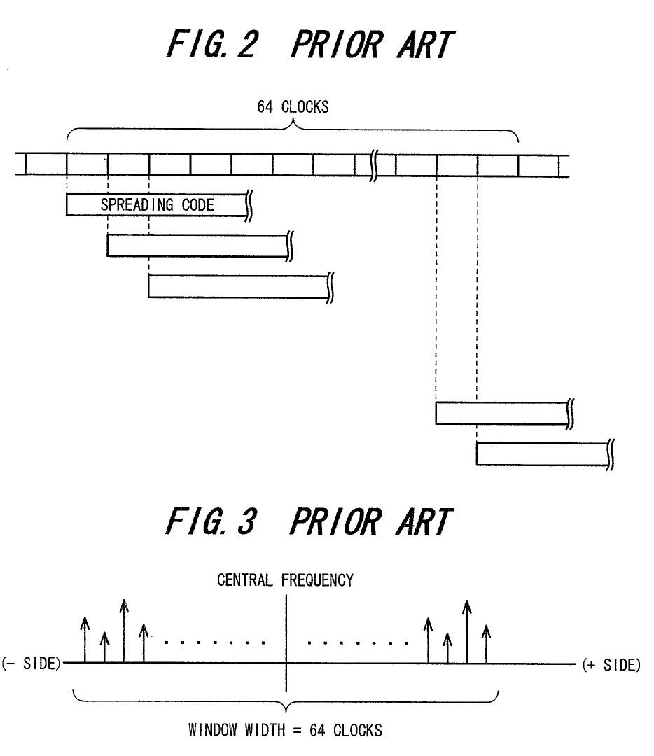

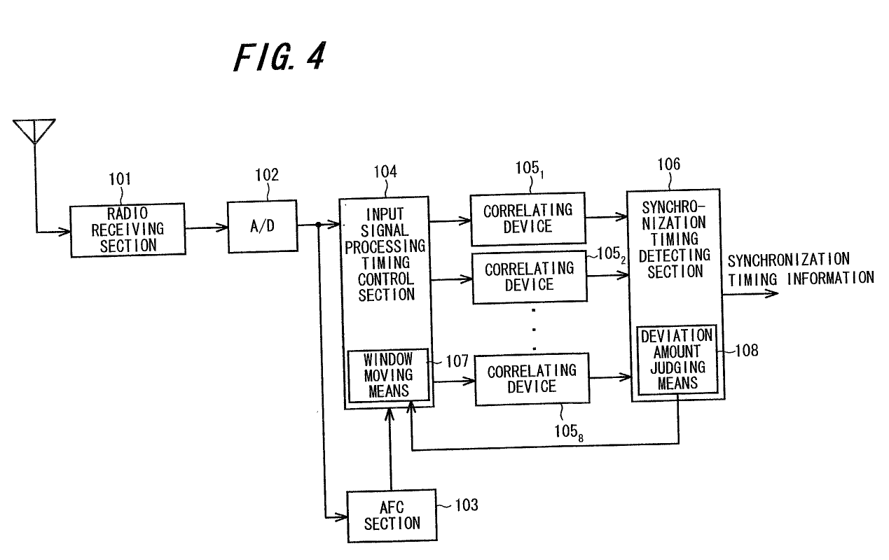

FIG. 4 is a block diagram showing a configuration of a CDMA receiver provided with a synchronization timing correcting circuit of a first embodiment of the present invention. In FIG. 4, the same constituent elements or parts as those in FIG. 1 are attached with the same reference numerals as those in FIG. 1 and explanation thereof will be omitted.

A synchronization timing correcting circuit of this embodiment comprises an input signal processing timing control section 104 provided with window moving means 107, correlating devices 105₁ to 105₈, and a synchronization timing detecting section 106 provided with deviation amount judging means 108.

The deviation amount judging means 108 detects a deviation amount and a deviation direction of a frequency central value set currently from a synchronization timing (synchronization value maximum timing) at which the maximum correlation value can be obtained by comparing correlation values from the respective correlating devices 105₁ to 105₈ with one another, determines a movement amount of the central frequency of the window on the basis of the deviation amount and the deviation direction, and outputs the movement amount determined to the window moving means 107 in the input signal processing timing control section 104. Here, the deviation amount judging means 108 detects the timing at which the correlation value becomes the maximum by comparing the correlation values from the respective correlating devices 105₁ to 105₈ with one another, averages differences between the current central frequency and the synchronization timing for a fixed period and judges the deviation amount and the deviation direction on the basis of the averaged value. Then, when the deviation amount exceeds a predetermined reference value, the position of the window is changed.

For example, when the average of the deviation amount over one frame section is obtained, the deviation amounts of fifteen time slots, namely the deviation amounts of fifteen timings are averaged. For example, in a case that the respective deviation amounts of 15 time slots are 2, 1, 2, 1, 0, 2, 3, 2, 2, 3, 4, 3, 3, 2 and 3, the average of these deviation amounts becomes 2.2. Then, when the reference value for judging whether or not the position of the window should be changed is one clock, the deviation amount judging means 108 performs change of the window position.

In this case, the deviation amount judging means 108 may be configured to move the central frequency of the window by two clocks corresponding to the obtained deviation amount or move it by one clock per one change or one movement.

The window moving means 107 performs change of the frequency central value of the window on the basis of a window position changing signal from the deviation amount judging means 108.

The input signal processing control section 104 does not set the synchronization timing captured by the AFC section 103 as a central frequency but produces signals within a range of ±4 clocks about the central frequency set by the window moving means to output them to the correlating devices 105₁ to 105₈.

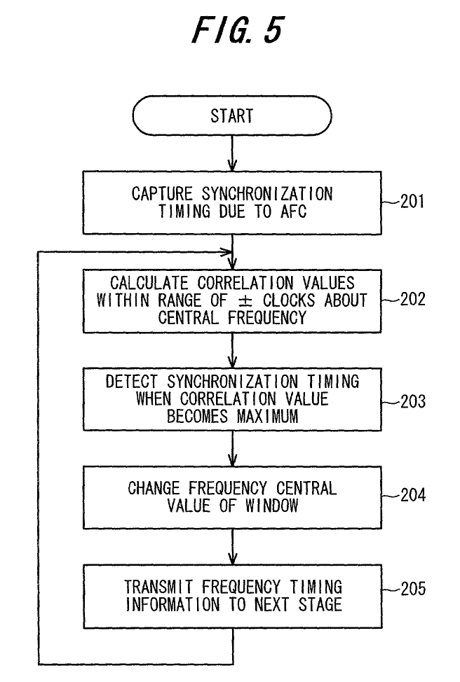

Next, operation of the synchronization timing correcting circuit of the present invention will be explained with reference to a flowchart in FIG. 5.

First, the AFC section 103 is input with a digital signal from the A/D converter 102 to capture a synchronization timing and output the captured synchronization timing into the input signal processing timing control section 504 (Step 201). Next, the window moving means 107 sets the central frequency of the synchronization timing captured by the AFC section 103 as the central frequency, and the input signal processing timing control section 104 outputs signals within the range of ±4 clocks about the central frequency to the correlating devices 105₁ to 105₈, respectively. Then, the respective correlating devices 105₁ to 105₈ perform respective correlation calculations to calculate correlation values (Step 202).

Next, in the deviation amount judging means 108 in the synchronization timing detecting section 106, a synchronization timing at which the correlation value becomes the maximum is detected on the basis of the respective correlation values from the correlating devices 105₁ to 105₈, and the synchronization timing is outputted to the window moving means 107 as a window position changing signal (Step 203). Then, in the window moving means 107, the frequency central value in the window is changed on the basis of the window position changing signal from the deviation amount judging means 108 (Step 204). Also, the synchronization timing information obtained from the synchronization timing detecting section 106 is sent to a circuit of the next stage, where such a processing as an inverse-spreading processing is performed using the synchronization timing information (Step 205).

Even when processing of Steps 202 to 205 is repeated using the central frequency which has been changed in Step 204 so that an error occurs in the AFC and the correlation value maximum timing moves, the position of the window itself is shifted along the direction in which the correlation value maximum timing moves so that the frequency shift due to an error in AFC or the like can be absorbed even when the window width is narrow.

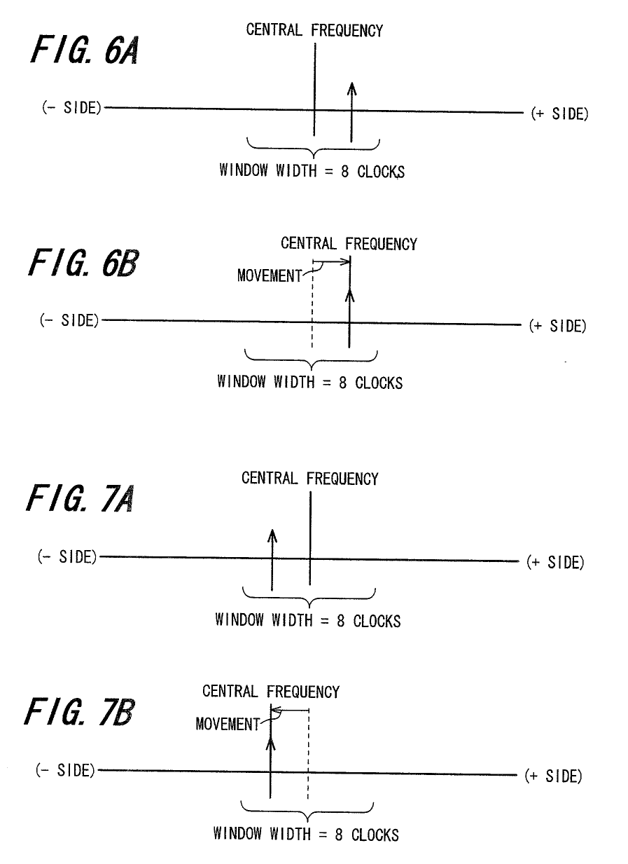

A timing correcting method when the correlation value maximum timing is moved towards (+side) within the window relative to the central frequency is shown in FIGS. 6A and 6B. In a case that it is judged from the judgement result in the deviation amount judging means 108 in the synchronization timing detecting section 106 shown in FIG. 4 that the correlation value maximum timing has been deviated towards +side from the central frequency, a window position changing signal is transmitted to the window moving means 107 of the input signal processing timing control section 104 so that the frequency central value of the window is changed to +direction.

A timing correcting method when the correlation value maximum timing is moved towards (−side) within the window relative to the central frequency is shown in FIGS. 7A and 7B. In a case that it is judged from the judgement result in the deviation amount judging means 108 in the synchronization timing detecting section 106 shown in FIG. 4 that the correlation value maximum timing has been deviated towards −side from the central frequency, a window position changing signal is transmitted to the window moving means 107 of the input signal processing timing control section 104 so that the frequency central value of the window is changed to−direction.

In the conventional synchronization timing correcting circuit, for example, in a case that an AFC error occurs in the range of ±32 clocks about the central frequency, the window width =64 clocks is required, also, 64 correlating devices is required. According to the synchronization timing correcting circuit of this embodiment, for example, even in a case that the window width=8 clocks is set, when the correlation value maximum timing moves due to an AFC error from the central frequency, the position of the window (frequency central value) itself is moved so as to correspond to the movement of the correlation value maximum timing so that it is made possible to continue capturing of the correlation value maximum timing while the correlation value maximum timing is being prevented from moving out of the window.

In comparison of a circuit scale in this case, in a case that the circuit scale per one of the correlating devices 105₁ to 105₆₄ is 10K gates, a circuit scale of 10K gates×64=640K gates is required in the conventional synchronization timing correcting circuit, but a circuit scale required in the synchronization timing correcting circuit of this embodiment is only 10K gates×8=80K gates, which results in reduction of 560 K gates.

Also, since pieces of the correlating device outputs must be processed in a calculating manner, respectively, the calculation processing is increased according to increase in window width. However, since it is made possible to set the window width to be narrow, an amount of calculation processing can be reduced. Furthermore, as mentioned above, because the circuit scale and the amount of calculation processing can be reduced, reduction in power consumption can be achieved.

(Second Embodiment)

Next, a synchronization timing correcting circuit of a second embodiment of the invention will be explained. The synchronization timing correcting circuit of this embodiment has almost the same configuration as that of the first embodiment, but both the synchronization timing circuit are different in a judging method for judging the deviation amount in the deviation amount judging means 108.

The deviation amount judging method in the synchronization timing correcting circuit of this embodiment will be explained below.

In the deviation amount judging method of this embodiment, the judgement value Y(n) which is a criterion about whether the frequency central value of the window should be changed is calculated on the basis of the following equation (1), and when the judgement value Y(n) exceeds a predetermined reference value, the frequency central value of the window is changed.

Y(n)=Z×Y(n−1)+(1−Z)×T (1)

,where Y(n) is a judgement value of this time, Y(n−1) is a judgement value of the previous time, and T is a deviation amount detected. Also, Z is a calculation coefficient, which is a value meeting

Z=calculation coefficient (0.0<Z<1.0)

In this embodiment, assuming that an initial value Y(0) of the judgement value is 0, the deviation amount is 1, 2, 3, 4 . . . , and Z=0.6,

Y(1)=0.6×y(0)(=0)+0.4×1=0.4

Y(2)=0.6×Y(1)(=0.4)+0.4×2=1.04

Y(3)=0.6×Y(1)(1.04)+0.4×3=1.824

Y(4)=0.6×Y(1)(=1.824)+0.4×4≈2.694

Then, when the judgement value Y(n) exceeds the predetermined reference value, the frequency central value of the window is changed like the first embodiment. Incidentally, even in this embodiment, the window position may be shifted once by only ±1 clock unit, or it may be shifted at once by the number of clocks corresponding to the deviation amount.

In this embodiment, by making judgement of the deviation amount using the above equations, even when a large deviation amount occurs due to any noise or the like, the judgement value can be prevented from increasing urgently, thereby preventing erroneous shifting of the window position.

In the above first and second embodiments, the case where the window width is set to 8 clocks has been explained, but the present invention is not limited to this window width. Even when the window width is set to another value, the present invention is applicable to such a window width.

Although the invention has been described with respect to specific embodiment for complete and clear disclosure, the appended claims are not to be thus limited but are to be construed as embodying all modification and alternative constructions that may be occurred to one skilled in the art which fairly fall within the basic teaching herein set forth.

What is claimed is:

1. A synchronization timing correcting circuit for correcting a synchronization timing of a base station which has been once captured, comprising: an input signal processing timing control section which has window moving means for, on the basis of a window position changing signal for instructing a change of a frequency central value of a window defining a range for monitoring a synchronization timing which has been once captured, changing the frequency central value of the window, and which produces signals within the window about the frequency central value set by the window moving means from a signal received from a base station;
a plurality of correlating devices which perform correlation values between the signals produced by the input signal processing timing control section and predetermined spreading codes, respectively; and
a synchronization timing detecting section which has deviation amount judging means for detecting a deviation amount and a deviation direction of a frequency central value of a window set currently from a synchronization timing which is a timing at which the correlation value becomes maximum by comparing the respective correlation values with one another to determine a movement amount of the central frequency of the window to be moved on the basis of the deviation amount and the deviation direction, and outputting the movement amount determined to the window moving means as the window position changing signal.

2. A synchronization timing correcting circuit according to claim 1, wherein the deviation amount judging means takes an average value of differences between a frequency central value set currently and the synchronization timing detected for a fixed period, and when the average value exceeds a predetermined reference value, change of the frequency central value of the window is made.

3. A synchronization timing correcting circuit according to claim 1, wherein the deviation amount judging means calculates a judgement value Y(n) using
Y(n)=Z×Y(n−1)+(1−Z)×T,
where Y(n) is a judgement value which is a criterion about whether or not the change of the frequency central value of the window should be made, Y(n−1) is the previous judgement value, T is a deviation amount detected, and Z is a calculation coefficient larger than 0 and smaller than 1, and when the judgement value Y(n) exceeds a predetermined reference value, change of the frequency central value of the window is made.

4. A synchronization timing correcting circuit according to claim 1, wherein the frequency central value is shifted by only one clock with to one time change.

5. A synchronization timing correcting circuit according to claim 2, wherein the frequency central value is shifted by only one clock with to one time change.

6. A synchronization timing correcting circuit according to claim 3, wherein the frequency central value is shifted by only one clock with to one time change.

7. A synchronization timing correcting circuit according to claim 1, wherein the frequency central value is shifted by the deviation amount detected with one time change.

8. A synchronization timing correcting circuit according to claim 2, wherein the frequency central value is shifted by the deviation amount detected with one time change.

9. A synchronization timing correcting circuit according to claim 3, wherein the frequency central value is shifted by the deviation amount detected with one time change.

10. A synchronization timing correcting method for correcting a synchronization timing of a base station which has been captured once, comprising the steps of:
producing signals within a window defining a range where the synchronization timing which has been captured once is monitored from a signal received from the base station to output the produced signals;
performing calculations of correlation values between the respective produced signals and predetermined spreading codes, respectively;
comparing the respective correlation values with one another to detect a deviation amount and a deviation direction of the frequency central value of the window set currently from a synchronization timing which is a timing at which the correlation value becomes the maximum; and
determining a deviation amount by which a central frequency of the window is moved on the basis of the deviation amount and the deviation direction to change the frequency central value of the window by the deviation amount determined.

11. A synchronization timing correcting method according to claim 10, wherein the step of detecting the deviation amount and the deviation direction comprises
a step of taking an average value of differences between the frequency central value set currently and the synchronization timing detected for a fixed period; and
a step of performing a change of the frequency central value of the window when the average value exceeds a predetermined reference value.

12. A synchronization timing correcting method according to claim 10, wherein the step of detecting the deviation amount and the deviation direction comprises
a step of calculating a judgement value Y(n) using
Y(n)=Z×Y(n−1)+(1−Z)×T,
where Y(n) is a judgement value which is a criterion about whether or not the change of the frequency central value of the window should be made, Y(n−1) is the previous judgement value, T is a deviation amount detected, and Z is a calculation coefficient larger than 0 and smaller than 1, and
a step of changing of the frequency central value of the window, when the judgement value Y(n) exceeds a predetermined reference value.

13. A synchronization timing correcting method according to claim 10, wherein the step of changing the frequency central value of the window moves the frequency central value of the window by only one clock with one time change.

14. A synchronization timing correcting method according to claim 11, wherein the step of changing the frequency central value of the window moves the frequency central value of the window by only one clock with one time change.

15. A synchronization timing correcting method according to claim 12, wherein the step of changing the frequency central value of the window moves the frequency central value of the window by only one clock with one time change.

16. A synchronization timing correcting method according to claim 10, wherein the step of changing the frequency central value of the window moves the frequency central value of the window by the deviation amount detected with one time change.

17. A synchronization timing correcting method according to claim 11, wherein the step of changing the frequency central value of the window moves the frequency central value of the window by the deviation amount detected with one time change.

18. A synchronization timing correcting method according to claim 12, wherein the step of changing the frequency central value of the window moves the frequency central value of the window by the deviation amount detected with one time change.
